(19) United States
(12) Patent Application Publication
(10) Pub. No.: US 2011/0255089 A1
(43) Pub. Date: Oct. 20, 2011

(54) Methods for Aligning Wavelength Converted Light Sources

(76) Inventors: Vikram Bhatia, Painted Post, NY (US); Dragan Pikula, Horseheads, NY (US)

(21) Appl. No.: 12/760,028

(22) Filed: Apr. 14, 2010

(51) Int. Cl. G01B 11/00

(52) U.S. Cl. 356/400

(57) ABSTRACT

A method for aligning a semiconductor laser to a wavelength conversion device in a wavelength converted light source includes positioning a beam spot of the semiconductor laser on an input facet of the wavelength conversion device. The beam spot is stepped in a scanning direction by a succession of steps. A wavelength control signal of the semiconductor laser is swept over an alignment signal range at the end point of individual steps of the succession of steps. The peak output power of a wavelength converted output beam emitted from the wavelength conversion device during the sweep is determined at the end point of individual steps of the succession of steps. The peak output power is compared to a threshold output power to determine if the beam spot is aligned with the waveguide of the wavelength conversion device.

### BACKGROUND

1. Field

The present specification generally relates to semiconductor lasers, laser controllers, wavelength converted light sources, and other optical systems incorporating semiconductor lasers. More specifically, the present specification relates to methods for aligning wavelength converted light sources that include, inter alia, a semiconductor laser optically coupled to a wavelength conversion device.

2. Technical Background

Wavelength converted light sources can be formed by combining a single-wavelength semiconductor laser, such as an infrared or near-infrared distributed feedback (DFB) laser, distributed Bragg reflector (DBR) laser, or Fabry-Perot laser, with a light wavelength conversion device, such as a second harmonic generation (SHG) crystal. Wavelength converted light sources of this type may be utilized in laser projection systems among other applications. Typically, the SHG crystal is used to generate higher harmonic waves of the fundamental beam of the semiconductor laser. In order to produce a wavelength converted output beam having the desired power, the wavelength of the fundamental beam must be tuned to the spectral center of the phase matching band of the wavelength converting SHG crystal when the fundamental beam of the semiconductor laser is aligned with the waveguide portion of the wavelength converting crystal.

Alignment of the wavelength converted light source is often performed during start-up of the device which introduces a delay between the time when the device is initially switched on and the time when the device is aligned and capable of producing a wavelength converted output beam. Accordingly, a need exists for alternative methods for rapidly aligning the fundamental beam of a semiconductor laser with a wavelength conversion device in a wavelength converted light source at device start up.

### SUMMARY

According to one embodiment, a method for aligning a semiconductor laser to a wavelength conversion device in a wavelength converted light source includes positioning a beam spot of the semiconductor laser on the input facet of the wavelength conversion device. and performing an alignment scan of the beam spot on the input facet by: stepping the beam spot in a first scanning direction by a succession of steps, wherein individual steps of the succession of steps comprise a start point and an end point; initiating and terminating a sweep of a wavelength control signal of the semiconductor laser over an alignment signal range at the end point of individual steps of the succession of steps; determining a peak output power of a wavelength converted output beam emitted from the wavelength conversion device during the sweep of the wavelength control signal of the semiconductor laser at the end point of individual steps of the succession of steps; and comparing the peak output power of the wavelength converted output beam to a threshold output power, wherein the beam spot is aligned with the waveguide portion of the wavelength conversion device when the peak output power is greater than the threshold output power.

In another embodiment, a method for aligning a semiconductor laser to a wavelength conversion device in a wavelength converted light source includes positioning a beam spot of the semiconductor laser on an alignment initiation point on an input facet of the wavelength conversion device and performing a first alignment scan of the beam spot on the input facet by: stepping the beam spot in a first scanning direction by a first succession of steps; sweeping a wavelength control signal of the semiconductor laser over an alignment signal range between individual steps of the first succession of steps; determining a peak output power of a wavelength converted output beam emitted from the wavelength conversion device while the wavelength control signal of the semiconductor laser is swept between individual steps of the first succession of steps; comparing the peak output power of the wavelength converted output beam to the threshold output power, wherein the beam spot is coarsely aligned with the wavelength conversion device when the peak output power is greater than the threshold output power. When the beam spot does not exceed the threshold output power during the first alignment scan, a second alignment scan of the beam spot on the input facet is performed by: stepping the beam spot away from an end point of the first alignment scan in an intermediate direction by at least one intermediate step; stepping the beam spot in a second scanning direction opposite the first scanning direction by a second succession of steps; sweeping the wavelength control signal of the semiconductor laser over the alignment signal range between individual steps of the second succession of steps; determining the peak output power of the wavelength converted output beam emitted from the wavelength conversion device while the wavelength control signal of the semiconductor laser is swept between individual steps of the second succession of steps; and comparing the peak output power of the wavelength converted output beam to the threshold output power, wherein the beam spot is coarsely aligned with the wavelength conversion device when the peak output power is greater than the threshold output power.

Additional features and advantages of the invention will be set forth in the detailed description which follows, and in part will be readily apparent to those skilled in the art from that description or recognized by practicing the embodiments described herein, including the detailed description which follows, the claims, as well as the appended drawings.

It is to be understood that both the foregoing general description and the following detailed description describe various embodiments and are intended to provide an overview or framework for understanding the nature and character of the claimed subject matter. The accompanying drawings are included to provide a further understanding of the various embodiments, and are incorporated into and constitute a part of this specification. The drawings illustrate the various embodiments described herein, and together with the description serve to explain the principles and operations of the claimed subject matter.

### BRIEF DESCRIPTION OF THE DRAWINGS

FIG. 1 schematically depicts one embodiment of a wavelength converted light source which may be used in conjunction with one or more of the alignment methods shown and described herein;

FIG. 2 schematically depicts one embodiment of a semiconductor laser for use in a wavelength converted light source;

FIG. 3 schematically depicts a cross section of one embodiment of a wavelength conversion device for use in a wavelength converted light source;

FIGS. 4A-4D schematically depict a method for aligning a wavelength converted light source according to one or more embodiments shown and described herein;

FIG. 5A schematically depicts a series of local alignment scans and a series of global alignment scan according to one or more embodiments of the method for aligning a wavelength converted light source shown and described herein; and

FIG. 5B schematically depicts aligning a beam spot on an input facet of a wavelength conversion device on a pair of fine scanning axes according to one or more embodiments of the alignment methods shown and described herein.

### DETAILED DESCRIPTION

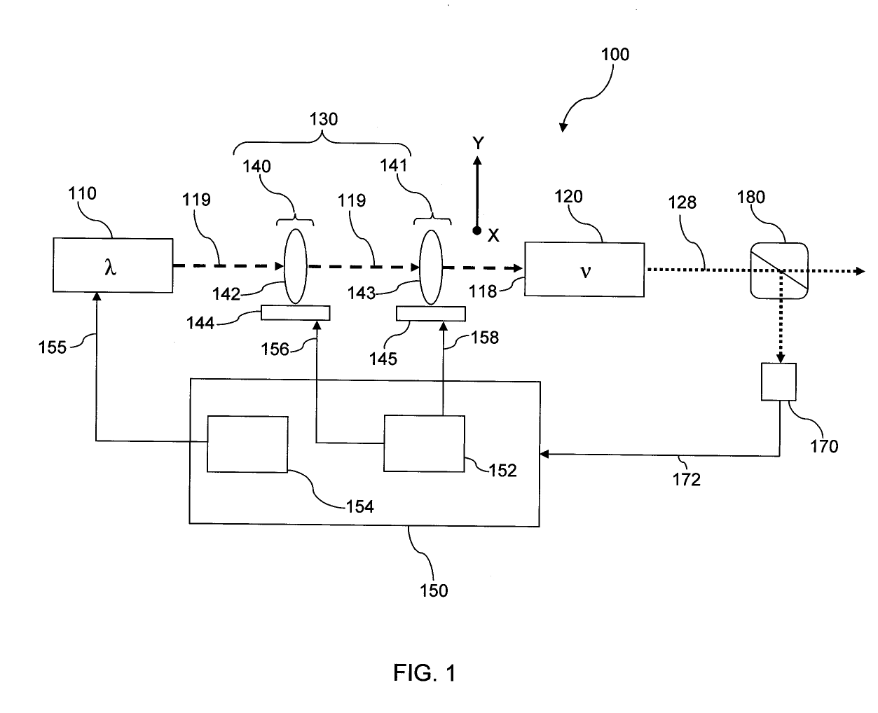

Reference will now be made in detail to various embodiments of methods for aligning wavelength converted light sources, examples of which are illustrated in the accompanying drawing. Whenever possible, the same reference numerals will be used throughout the drawings to refer to the same or like parts. One embodiment of a wavelength converted light source for use in conjunction with the alignment methods described herein is shown in FIG. 1. The wavelength converted light source generally comprises a semiconductor laser, adaptive optics, a wavelength conversion device and a package controller. The output of the semiconductor laser is optically coupled into the input facet of the wavelength conversion device with the adaptive optics. The package controller is electrically coupled to the semiconductor laser and the adaptive optics and configured to control the output of the semiconductor laser and the alignment of the semiconductor laser with the wavelength conversions device in order to rapidly align the fundamental beam of the semiconductor laser with the waveguide portion of the wavelength conversion device when the wavelength converted light source is powered on. Various components and configurations of the wavelength converted light source and methods for aligning the wavelength converted light source will be described in more detail herein.

FIG. 1 generally depicts one embodiment of wavelength converted light source 100 which may be used in conjunction with the alignment methods described herein. It should be understood that the solid lines and arrows in FIG. 1 generally indicate the electrical interconnectivity of various components of the wavelength converted light source. These solid lines and arrows are also indicative of electrical signals propagated between the various components including, without limitation, electronic control signals, data signals and the like. Further, it should also be understood that the dashed lines and arrows are indicative of coherent beams of electromagnetic radiation emitted by the semiconductor laser and the wavelength conversion device.

Referring initially to FIG. 1, the wavelength converted light source 100 generally comprises a semiconductor laser 110 optically coupled to a wavelength conversion device 120. The fundamental beam 119 emitted by the semiconductor laser 110 is coupled into the waveguide portion of wavelength conversion device 120 using adaptive optics 130. The wavelength conversion device 120 converts the fundamental beam 119 into higher harmonic waves and outputs a wavelength converted output beam 128. This type of wavelength converted light source is particularly useful in generating shorter wavelength laser beams from longer wavelength semiconductor lasers and can be used, for example, as a visible laser source for laser projection systems.

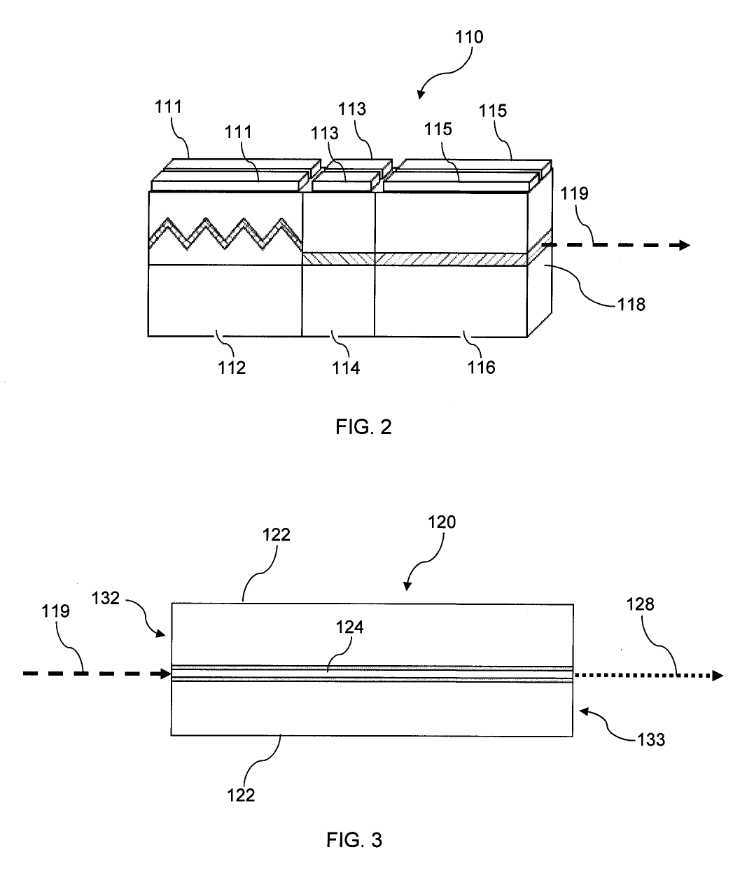

The semiconductor laser 110, which is schematically illustrated in FIG. 2, generally comprises a wavelength selective section 112, a phase matching section 114, and a gain section 116. The wavelength selective section 112, which may also be referred to as the distributed Bragg reflector or DBR section of the semiconductor laser 110, typically comprises a first order or second order Bragg grating positioned outside the active region of the laser cavity. This section provides wavelength selection as the grating acts as a mirror whose reflection coefficient depends on the wavelength. The gain section 116 of the semiconductor laser 110 provides the major optical gain of the laser and the phase matching section 114 creates an adjustable optical path length or phase shift between the gain material of the gain section 116 and the reflective material of the wavelength selective section 112. The wavelength selective section 112 may be provided in a number of suitable alternative configurations that may or may not employ a Bragg grating.

Respective control electrodes 111, 113, 115 are incorporated in the wavelength selective section 112, the phase matching section 114, the gain section 116, or combinations thereof, and are merely illustrated schematically in FIG. 2. The control electrodes 111, 113, 115 can be used to inject electrical current into the corresponding sections 112, 114, 116 of the semiconductor laser 110. For example, in one embodiment, current injected in to the wavelength selective section 112 of the semiconductor laser 110 can be used to control the wavelength λ₁ of the fundamental beam 119 emitted from the output facet 118 of the semiconductor laser 110 by altering the operating properties of the laser. The injected current may be used to control the temperature of the wavelength selective section 112 or the index of refraction of the wavelength selective section. Accordingly, by adjusting the amount of current injected into the wavelength selective section, the wavelength of the fundamental beam 119 emitted by the semiconductor laser may be varied. Current injected into the phase matching section 114 or gain section 116 may be similarly used to control the output of the semiconductor laser 110.

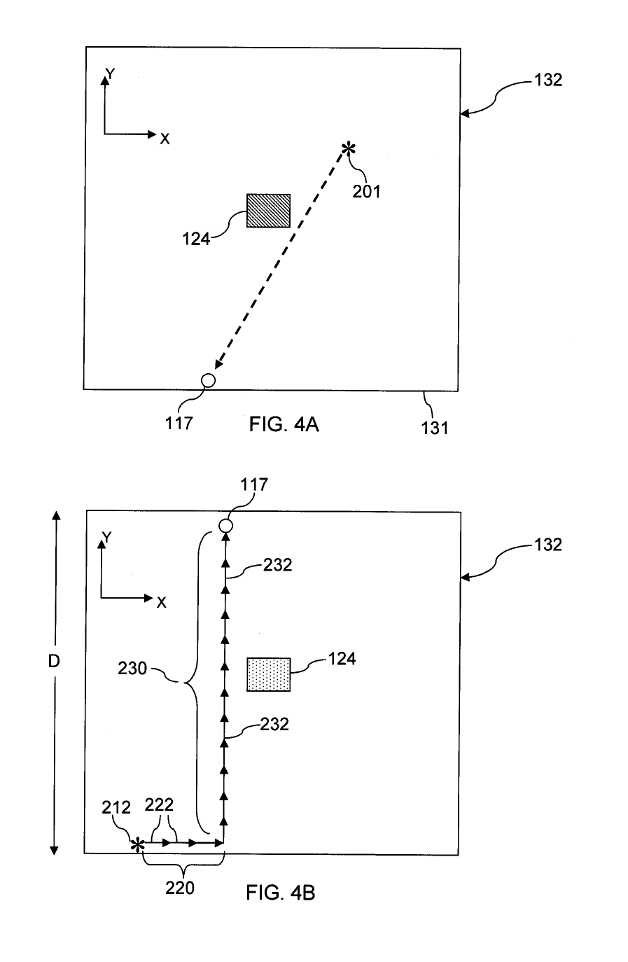

Referring to FIG. 3, one embodiment of a wavelength conversion device 120 is schematically depicted in cross section. The wavelength conversion device 120 generally comprises a bulk crystal material 122, such as MgO-doped lithium niobate, with a waveguide portion 124 which extends between an input facet 132 and an output facet 133. In one embodiment, the waveguide portion is a periodically-poled lithium niobate (PPLN) crystal. In this embodiment, the waveguide portion 124 may have dimensions (e.g., height and width) on the order of 5 microns. While the wavelength conversion device is described herein as comprising an MgO-doped lithium niobate bulk crystal with a PPLN waveguide, it should be understood that other, similar non-linear optical crystals and/or waveguides may be used. Further, it should be understood that the wavelength conversion device may be a second harmonic generation (SHG) crystal or a non-linear optical crystal capable of converting light to higher order (e.g., 3^{rd}, 4^{th}, etc.) harmonics.

Still referring to FIG. 3, when a fundamental beam having a first wavelength λ₁ is directed into the waveguide portion 124 of the wavelength conversion device 120, such as the fundamental beam 119 of the semiconductor laser 110, the fundamental beam may be propagated along the waveguide portion 124 of the wavelength conversion device 120 where the fundamental beam is converted to a second wavelength λ₂. The wavelength conversion device 120 emits the wavelength converted output beam 128 from the output facet 133. For example, in one embodiment, the fundamental beam 119 produced by the semiconductor laser 110 and directed into the waveguide portion 124 of the wavelength conversion device 120 has a wavelength of about 1060 nm (e.g., the fundamental beam 119 is an infrared light beam). In this embodiment, the wavelength conversion device 120 converts the infrared light beam to visible light such that the waveguide portion 124 of the wavelength conversion device emits a wavelength converted output beam 128 with a wavelength of about 530 nm (e.g., visible green light).

Referring now to FIGS. 1-3, one embodiment of a wavelength converted light source 100 is depicted in which the semiconductor laser 110 and the wavelength conversion device 120 have a substantially linear configuration. More specifically, the output of the semiconductor laser 110 and the input of the wavelength conversion device 120 are substantially aligned along a single optical axis. As shown in FIG. 1, the fundamental beam 119 emitted by the semiconductor laser 110 is directed on to the waveguide portion of the wavelength conversion device 120 with adaptive optics 130.

In the embodiment shown in FIG. 1, the adaptive optics 130 generally comprises a pair of lens assemblies 140, 141. Each lens assembly 140, 141 generally comprises a lens 142, 143 affixed to a respective actuator 144, 145. In the embodiments described herein, the first lens 142 is a collimating lens which collimates the fundamental beam 119 of the semiconductor laser 110 while the second lens 143 is focusing lens which focuses the fundamental beam 119 of the semiconductor laser 110. In the embodiments described herein, the actuators 144, 145 are smooth impact drive mechanisms (SIDMs). The SIDMs may be actuated by applying an electrical control signal, specifically an electrical control pulse or series of electrical control pulses which produces a linear motion in the SIDM. The polarity of the pulse determines the direction of motion of the SIDM. However, it should be understood that other actuators may also be used including, without limitation, micro-electro-mechanical system (MEMs) actuators or the like. The first actuator 144 facilitates moving the first lens 142 in the x-direction. The second actuator 145 facilitates moving the second lens 143 in the y-direction. Adjusting the position of the first lens in the x-direction and the second lens in the y-direction facilitates positioning the fundamental beam 119 along the input facet of the wavelength conversion device 120 to align the fundamental beam 119 with the waveguide portion of the wavelength conversion device 120.

Still referring to FIG. 1, the wavelength converted light source 100 may also comprise a beam splitter 180 positioned proximate the output of the wavelength conversion device 120. The beam splitter 180 is used to redirect a portion of the wavelength converted output beam 128 emitted from the wavelength conversion device 120 into an optical detector 170 which is used to measure the intensity of the emitted wavelength converted output beam 128 and output an electrical signal proportional to the measured intensity.

The wavelength converted light source 100 may also comprise a package controller 150. The package controller 150 may comprise one or more micro-controllers used to store and execute a programmed instruction set for operating the wavelength converted light source 100. The package controller 150 is electrically coupled to the semiconductor laser 110, the adaptive optics 130 and the optical detector 170 and programmed to operate both the semiconductor laser 110 and the adaptive optics 130. More specifically, in one embodiment, the package controller 150 may comprise drivers 152, 154 for controlling the adaptive optics and the wavelength selective section of the semiconductor laser, respectively.

The adaptive optics driver 152 may be coupled to the adaptive optics 130 with leads 156, 158 and supplies the adaptive optics 130 with x- and y-position control signals through the leads 156, 158, respectively. The x- and y-position control signals facilitate positioning the lenses 142, 143 of the adaptive optics in the x- and y-directions which, in turn, facilitates positioning the fundamental beam 119 of the semiconductor laser 110 on the input facet of the wavelength conversion device 120. For example, when the adaptive optics 130 comprises a pair of lens assemblies 140, 141, as shown in FIG. 1, the x- and y-position control signals may be used to position the lenses 142, 143 in the x- and y-directions, respectively by supplying control signals to the actuators 144, 145.

The wavelength selective section driver 154 may be coupled to the semiconductor laser 110 with lead 155. The wavelength selective section driver 154 may supply the wavelength selective section 112 of the semiconductor laser 110 with wavelength control signals which facilitate adjusting the wavelength λ₁ of the fundamental beam 119 emitted from the output facet of the semiconductor laser 110.

Further, the output of the optical detector 170 may be electrically coupled to an input of the package controller 150 with lead 172 such that the output signal of the optical detector 170 is passed to the package controller 150.

Methods of operating the wavelength converted light sources 100 to rapidly align the fundamental beam of the semiconductor laser with the waveguide portion of the wavelength conversion device will now be described in more detail with specific reference to FIGS. 1, 4A-4D and 5A-5B.

In describing various embodiments of the alignment methods, reference will be made to determining the peak output power of the wavelength conversion device for particular positions of a beam spot of the semiconductor laser 110 on the input facet 132 of the wavelength conversion device 120. In each instance, the peak output power of the wavelength conversion device is determined by performing a sweep of the wavelength control signal supplied to the wavelength control section of the semiconductor laser 110 by the wavelength selective section driver 154 over a predetermined alignment signal range which, in turn, varies the wavelength of the fundamental beam 119 emitted by the semiconductor laser. The alignment signal range is a voltage or current range which varies the wavelength of the fundamental beam over a predetermined range of wavelengths that are known to produce phase matching between the semiconductor laser and the wavelength conversion device when the fundamental beam 119 is positioned on the waveguide portion 124 of the wavelength conversion device 120. Accordingly, when a beam spot 117 of the fundamental beam 119 is positioned on the waveguide portion 124 of the wavelength conversion device 120 and the wavelength control signal is swept over the alignment signal range, the output power of the wavelength converted output beam 128 of the wavelength conversion device 120 varies with the wavelength control signal. The output power of the wavelength conversion device 120 may be measured with the optical detector 170 which propagates a signal to the package controller 150 indicative of the output power of the wavelength conversion device.

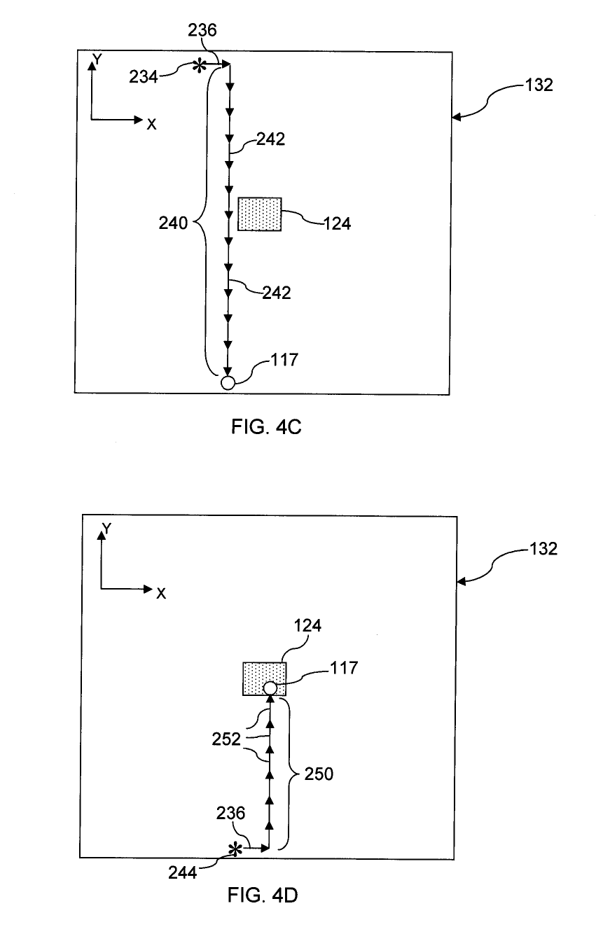

Referring now to FIGS. 1 and 4A-4D, the fundamental beam 119 of the semiconductor laser 110 is directed onto a start-up position 201 on the input facet 132 of the wavelength conversion device 120 utilizing the adaptive optics 130 when the wavelength converted light source is powered. The start-up position 201 is not a pre-programmed position but is, instead, determined based on the position of the adaptive optics 130 when the wavelength converted light source is powered-on. Thereafter, the peak output power of the wavelength conversion device 120 is determined for the start-up position 201 of the beam spot 117 to determine if the fundamental beam 119 is in coarse alignment with the waveguide portion 124 of the wavelength conversion device 120 when the wavelength converted light source is initially powered on. The package controller 150 compares the peak output power measured during the sweep to a predetermined threshold output power. If the peak output power of the wavelength conversion device is greater than a predetermined threshold output power, the fundamental beam 119 is coarsely aligned with the waveguide portion 124 of the wavelength conversion device 120 and the controller initiates one or more algorithms to optimize the output power of the wavelength conversion device 120, as will be described in more detail herein. However, if the peak output power of the wavelength converted output beam is less than the threshold output power, the fundamental beam 119 is not aligned with the waveguide portion 124 of the wavelength conversion device 120 and the controller prepares to initiate a first alignment scan of the fundamental beam 119 of the semiconductor laser 110 over the input facet 132 of the wavelength conversion device 120. In the embodiments described herein, it should be understood that the threshold output power is the minimum output power emitted by the wavelength conversion device when the beams spot of the fundamental beam is positioned on the waveguide portion 124 of the wavelength conversion device under phase-matched conditions.

In one embodiment, before the first alignment scan is initiated, the beam spot 117 of the fundamental beam 119 is repositioned from the unaligned start-up position 201 to an alignment initiation point 212 (depicted in FIG. 4B) on the input facet 132 of the wavelength conversion device 120. In one embodiment where SIDM actuators are used in the adaptive optics 130, the SIDM actuators do not have an absolute reference in the x- and y-directions with respect to the input facet 132 of the wavelength conversion device 120. In this embodiment, the alignment initiation point 212 is utilized as a starting point for the first alignment scan. In the embodiments described herein, the beam spot 117 is positioned on the alignment initiation point 212 by driving at least one of the actuators of the adaptive optics by a large amount in one direction. For example, in the embodiment shown in FIG. 4A, the displacement of the actuator 145 in the second lens assembly 141 is maximized by providing the actuator with a y-position control signal which is sufficient to drive the actuator to its end position or its approximate end position in one direction such that, when the actuator is used to step the beam spot in the opposite direction, a substantial portion of the full range of travel of the actuator may be used. In the embodiment shown in FIG. 4A, the alignment initiation point 212 is depicted proximate the edge 131 of the input facet 132 in the negative y-direction. However, in other embodiments, the alignment initiation point 212 may be beyond an edge of the input facet (i.e., the alignment initiation point 212 is not located on the input facet).

Where the beam spot 117 is positioned at the alignment initiation point 212 by maximizing the displacement of a single actuator (i.e., the actuator 144 or the actuator 145 of FIG. 1) in one direction, the alignment initiation point 212 is a local alignment initiation point. Where the alignment initiation point 112 is a local alignment initiation point, the actuator which is not driven to its maximum displacement is adjusted by a small percentage of its maximum displacement. FIG. 4A schematically depicts positioning a beam spot 117 at a local alignment initiation point by maximizing the displacement of the actuator 145 in the negative y-direction and adjusting the actuator 144 by a fraction of the maximum displacement in the negative x-direction. In one embodiment, predetermined x-position and y-position control signals are utilized to position the beam spot 117 on the alignment initiation point 212. Where the alignment initiation point is a local alignment initiation point, the subsequent alignment scans are local alignment scans.

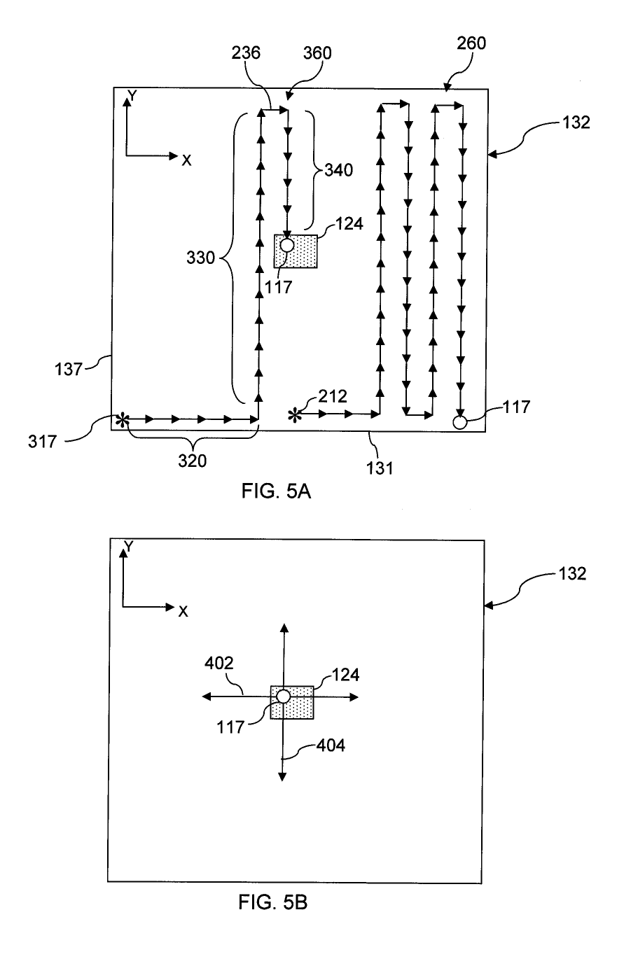

Referring to FIGS. 1 and 5A, in another embodiment, the alignment initiation point is a global alignment initiation point, such as the global alignment initiation point 317. In this embodiment, the predetermined x-position and y-position control signals are utilized to position the beam spot 117 by maximizing the displacement of each actuator 144, 145 in a specified direction. For example, in the embodiment depicted in FIG. 5A, the displacement of the actuator 145 is maximized in the negative y-direction while the displacement of the actuator 144 is maximized in the negative x-direction. In one embodiment the global initiation point 317 is located proximate two adjacent edges 131, 137 of the input facet of the wavelength conversion device. However, it should be understood that the global initiation point may be positioned beyond an edge of the input facet 134, such as when the global initiation point is not located on the input facet 134.

While the beam spot 117 may be positioned at an alignment initiation point (either local or global) by maximizing the displacement of one or both actuators in one direction, it should be understood that, in other embodiments, the alignment initiation point may also be obtained by adjusting the range of travel of one or both actuators by less than the maximum displacement.

In the embodiments described hereinabove the beam spot 117 is repositioned to an alignment initiation point before a first alignment scan is performed. However, it should be understood that, in other embodiments, the beam spot 117 is not repositioned to an alignment initiation point before the first alignment scan is performed. For example, the first alignment scan may be performed from the start-up position 201 of the beam spot 117.

Referring now to FIG. 4B, in one embodiment, the beam spot 117 is advanced in an intermediate scanning direction by a plurality of intermediate steps 220 after the beam spot 117 is positioned at the alignment initiation point 212 and before the first alignment scan is performed. In the embodiment shown in FIG. 4B, the intermediate scanning direction is in the positive x-direction of the coordinate axes illustrated in the figure. While the plurality of intermediate steps 220 is depicted in FIG. 4B as comprising three intermediate steps 222, it should be understood that the number of intermediate steps 222 in the plurality of intermediate steps 220 may be more than 3 or less than 3. For example, in one embodiment, the plurality of intermediate steps 220 comprises 10 intermediate steps 222. Further, in the embodiments described herein, each intermediate step 222 may have a step length (i.e., the length between the start point of the step and the end point of the step) of less than or equal to 5 microns, more preferably, less than or equal to 4 microns. However, it should be understood that larger or smaller step lengths may be utilized.

Scanning the beam spot 117 in the intermediate scanning direction is facilitated by supplying an x-position control signal to the adaptive optics 130 which, in turn, adjusts the position of the beam spot 117 in the x-direction on the input facet 132 of the wavelength conversion device 120. In one embodiment, where the adaptive optics comprises SIDM actuators, the x-position control signal for each intermediate step 222 may comprise a plurality of discrete pulses which advance the beam spot 117 from the start point of each intermediate step 222 to an end point of each intermediate step 222. For example, in one embodiment, the number of discrete pulses for each step in the first scanning direction is 50. However, it should be understood that the number of discrete pulses in each step may be greater than 50 or less than 50.

Referring to FIGS. 1 and 4B, after the beam spot 117 has been advanced away from the alignment initiation point 212 in an intermediate scanning direction by a plurality of intermediate steps 220, a first alignment scan of the beam spot 117 is performed by stepping the beam spot 117 in a first scanning direction by a first succession of steps 230. In the embodiment shown in FIG. 4B, the first scanning direction is in the positive y-direction. In the embodiment depicted in FIG. 4B, the first succession of steps 230 is depicted as comprising twelve steps 232 for purposes of illustration. However, in practice, the number of steps 232 in the first succession of steps 230 is greater than twelve. For example, where the alignment initiation point is either a global alignment initiation point (i.e., the first alignment scan is a first global alignment scan) or a local alignment initiation point (i.e., the first alignment scan is a first local alignment scan), the first succession of steps 230 corresponds to adjusting the actuator 145 through a maximum range of travel. In one embodiment, the maximum range of travel of the actuator is from about 600 steps to about 800 steps. In general, each step 232 in the first succession of steps 230 has a length which is less than the length of each intermediate step 222.

In another embodiment (not shown), the first succession of steps corresponds to adjusting the actuator 145 over a range of travel which is less than the maximum range of travel of the actuator 145. For example, in one embodiment, if the maximum range of travel of the actuator corresponds to 800 steps, then the number of steps N1 in the first succession of steps is less than 800. This embodiment may be used when the alignment initiation point is a global alignment initiation point and the first alignment scan is a global alignment scan in order to decrease the number of steps in the first succession of steps and thereby increase the speed of the first alignment scan.

In the embodiments described herein, scanning the beam spot 117 in the first scanning direction is facilitated by supplying a y-position control signal to the adaptive optics 130 which, in turn, adjusts the position of the beam spot 117 in the positive y-direction on the input facet 132 of the wavelength conversion device. In one embodiment, where the adaptive optics comprises SIDM actuators as described above with respect to the embodiment of the wavelength converted light source illustrated in FIG. 1, the y-position control signal for each step 232 may comprise a plurality of discrete pulses which advance the beam spot 117 from the start point of each step 232 to the end point of each step 232. In one embodiment, the number of discrete pulses for each step in the first scanning direction is 20 in order to achieve the desired step length. However, it should be understand that the number of discrete pulses in each step may be greater than 20 or less than 20.

As the beam spot 117 is stepped in the first scanning direction, the peak output power of the wavelength conversion device 120 is determined by initiating and terminating a sweep of the wavelength control signal over an alignment signal range between individual steps of the first succession of steps 230 (i.e., at the end point of individual steps of the first succession of steps). The package controller 150 compares the peak output power measured during the sweep to a predetermined threshold output power. If the peak output power of the wavelength conversion device is greater than a predetermined threshold output power, the fundamental beam 119 is coarsely aligned with the waveguide portion 124 of the wavelength conversion device 120 and the controller initiates one or more algorithms to optimize the output power of the wavelength conversion device 120. However, if the peak output power of the wavelength converted output beam is less than the threshold output power, the fundamental beam 119 is not aligned with the waveguide portion 124 of the wavelength conversion device 120 and the first alignment scan is continued.

As depicted in FIG. 4B, the first succession of steps 230 is completed without the beam spot 117 being positioned on the waveguide portion 124 of the wavelength conversion device. Under such conditions, the peak output power determined during the sweep of the wavelength control signal after each step in the first succession of steps 230 has not exceeded the threshold output power thus necessitating a second alignment scan of the beam spot 117 over the input facet 132 of the wavelength conversion device 120.

Referring now to FIGS. 1 and 4C, the second alignment scan begins with the beam spot 117 positioned at the end point 234 of the first alignment scan. The second alignment scan is performed by first stepping the beam spot 117 away from the end point 234 of the first alignment scan in an intermediate scanning direction (i.e., in the positive x-direction in the embodiment depicted) by at least one intermediate step 236. This is facilitated by providing the adaptive optics 130 with an x-position control signal with the adaptive optics driver 152, as described above. After the beam spot 117 is stepped in the intermediate scanning direction, the peak output power of the wavelength conversion device 120 is determined for the present location of the beam spot 117, as described above. If the peak output power of the wavelength converted output beam is greater than the threshold output power, the fundamental beam 119 is coarsely aligned with the waveguide portion 124 of the wavelength conversion device 120 and the controller initiates one or more algorithms to optimize the output power of the wavelength conversion device 120.

However, if the peak output power of the wavelength converted output beam 128 is less than the threshold output power, the beam spot 117 is stepped in a second scanning direction opposite the first scanning direction by a second succession of steps 240. In the embodiment shown in FIG. 4C, the second scanning direction is in the negative y-direction. In the embodiment depicted in FIG. 4C, the second succession of steps 240 is depicted as comprising four steps 242 for purposes of illustration. However, in practice, the number of steps 242 in the second succession of steps 240 is greater than four. In one embodiment the number of steps N2 in the second succession of steps 240 may be the same as the number of steps N1 in the first succession of steps 230.

However, in alternative embodiments (not shown), the number of steps N2 in the second succession of steps 240 is greater than the number of steps N1 in the first succession of steps 230 in order to account for drift in the control signals applied to the adaptive optics. For example, in one embodiment, the number of steps N2 in the second succession of steps 240 is greater than the number of steps N1 in the first succession of steps 230 by a factor of 1.3 (i.e., N2=1.3*N1). This embodiment is particularly useful when the alignment initiation point is a global alignment initiation point and the number of steps in the first succession of steps 230 is less than the number of steps which corresponds to the maximum range of travel of the actuator 145. It should also be understood that the length of each step 242 in the second scanning direction is less than the length of each intermediate step 222.

Scanning the beam spot 117 in the second scanning direction is facilitated by supplying a y-position control signal to the adaptive optics 130 which, in turn, adjusts the position of the beam spot 117 in the negative y-direction. Where the adaptive optics comprises SIDM actuators, the y-position control signal for each step 242 may comprise a plurality of discrete pulses which advance the beam spot 117 from the start point of each step 242 to the end point of each step 242, as described above with respect to the first succession of steps 230. For example, in one embodiment, the number of discrete pulses for each step in the second scanning direction is 20. However, it should be understand that the number of discrete pulses in each step may be greater than 20 or less than 20.

As the beam spot 117 is stepped in the second scanning direction, the peak output power of the wavelength conversion device 120 is determined by initiating and terminating a sweep of the wavelength control signal over an alignment signal range between individual steps of the second succession of steps 240 (i.e., at the end point of individual steps of the second succession of steps). The package controller 150 compares the peak output power measured during the sweep to a predetermined threshold output power. If the peak output power of the wavelength conversion device is greater than a predetermined threshold output power, the fundamental beam 119 is coarsely aligned with the waveguide portion 124 of the wavelength conversion device 120 and the package controller 150 initiates one or more algorithms to optimize the output power of the wavelength conversion device 120. However, if the peak output power of the wavelength converted output beam is less than the threshold output power, the fundamental beam 119 is not aligned with the waveguide portion 124 of the wavelength conversion device 120 and the second alignment scan is continued.

In the embodiment of the second alignment scan depicted in FIG. 4C, the second alignment scan is completed without the beam spot 117 being positioned on the waveguide portion 124 of the wavelength conversion device. Under such conditions, the peak output power measured after each step in the second succession of steps 230 has not exceeded the threshold output power thus necessitating additional alignment scans of the beam spot 117 over the input facet 132 of the wavelength conversion device 120.

Referring to FIG. 4D by way of example, after the second alignment scan is completed without the peak output power exceeding the threshold output power, the beam spot 117 is positioned at the end point 244 of the second alignment scan. Before proceeding with additional alignment scans, the beam spot 117 is advanced in the intermediate scanning direction by at least one intermediate 236. After the beam spot 117 is stepped in the intermediate scanning direction, the peak output power of the wavelength conversion device is determined as described above. If the peak output power of the wavelength converted output beam is greater than the threshold output power the fundamental beam 119 is roughly aligned with the waveguide portion 124 of the wavelength conversion device 120 and the controller initiates one or more control algorithms to optimize the output power of the wavelength converted output beam 128. However, if the peak output power of the wavelength converted output beam is not greater than the threshold output power, alignment scans in the first scanning direction and the second scanning direction are alternately repeated with at least one intermediate step in the intermediate scanning direction between successive alignment scans until the peak output power of the wavelength conversion device exceeds the threshold power or until the total number of intermediate steps in the series of alignment scans exceeds a maximum number of intermediate steps.

In one embodiment, when the alignment initiation point 212 is a local alignment initiation point, the maximum number of intermediate steps may be less than the maximum number of intermediate steps when the alignment initiation point is a global alignment initiation point. For example, in one embodiment, when the alignment initiation point is a local alignment initiation point, the maximum number of intermediate steps in the series of alignment scan may be 10 steps. Alternatively, when the alignment initiation point is a global alignment initiation point, the maximum number of intermediate steps may be about 200 steps. However, it should be understood that the maximum number of intermediate steps may be more or less depending on the specific step size used, the maximum range of travel of the actuators and/or the dimensions of the waveguide portion 124 of the wavelength conversion device.

In one embodiment, the maximum number of intermediate steps includes the plurality of intermediate steps taken after the beam spot 117 is positioned on the alignment initiation point 212. In another embodiment, the maximum number of intermediate steps is 60 steps, exclusive of the plurality intermediate steps taken after the beam spot 117 is positioned on the alignment initiation point 212 and before the first alignment scan is performed.

In the series of alignment scans depicted in FIGS. 4B-4D, the second alignment scan is completed without the beam spot being positioned on the waveguide portion of the input facet 132, the beam spot 117 is positioned on the waveguide portion 124 of the input facet 132 of the wavelength conversion device during the next succession of steps 250 in the first scanning direction following the second succession of steps 240 in the second scanning direction, at which point the alignment scans are terminated and the package controller initiates one or more control algorithms to optimize the output of the wavelength conversion device.

Referring to FIGS. 1 and 5B by way of example, when the peak output power of the wavelength conversion device exceeds the threshold power, the beam spot 117 is coarsely aligned with the waveguide portion 124 of the wavelength conversion device 120 and the package controller 150 terminates the alignment scans. Thereafter, the package controller 150 initiates one or more control algorithms to optimize the output power of the wavelength conversion device by refining the alignment of the beam spot 117 with the waveguide portion 124. In one embodiment, to refine the alignment of the beam spot 117 with the waveguide portion 124, the beam spot 117 is scanned over a portion of the input facet 132 on a first fine scanning axis 402 which is substantially parallel with the x-direction of the coordinate axes depicted in the figure. As the beam spot 117 is scanned on the first fine scanning axis 402, the output power of the wavelength converted output beam 128 emitted from the wavelength conversion device 120 is measured. A first alignment set point along the first fine scan axis is determined by the package controller 150 at the location of the beam spot 117 on the first fine scanning axis 402 where the output power of the wavelength conversion device is a maximum.

Thereafter, the beam spot 117 is scanned over a portion of the input facet 132 on a second fine scanning axis 404 which is substantially perpendicular with the first fine scanning axis. As the beam spot 117 is scanned on the second fine scanning axis 404, the output power of the wavelength converted output beam 128 emitted from the wavelength conversion device 120 is measured. A second alignment set point along the second fine scanning axis 404 is determined by the package controller 150 at the location of the beam spot 117 on the second fine scanning axis 404 where the output power of the wavelength conversion device 120 is a maximum. The beam spot 117 is then positioned on the input facet 132 utilizing the first alignment set point and the second alignment set point.

In another embodiment, after the beam spot 117 is positioned with the first alignment set point and the second alignment set point, the wavelength control signal is swept over the alignment signal range to determine a value of the wavelength control signal where the output power of the wavelength conversion device is maximized. Once the wavelength control signal is determined, the package controller initiates closed-loop feed back control of the wavelength converted light source.

In the foregoing description the alignment initiation point has been described as being a local alignment initiation point or a global alignment initiation point. In one embodiment, a series of local alignment scans (i.e., alignment scans starting from a local alignment initiation point) may be supplemented with a series of global alignment scans (i.e., alignment scans starting from a global alignment initiation point). Referring to FIG. 5A, under certain conditions it is possible that a series of local alignment scans may not yield alignment of the beam spot 117 with the waveguide portion 124 before the maximum number of initial steps is reached. For example, the position of the beam spot 117 at the start-up of the wavelength converted light source (i.e., the position of the beam spot 117 prior to positioning the beam spot 117 at the alignment initiation point 212), may be such that the beam spot 117 is never positioned on the waveguide portion 124 during the series of local alignment scans 260 starting at the local alignment initiation point 212. FIG. 5A schematically depicts such as scenario.

More specifically FIG. 5A graphically illustrates a series of local alignment scans 260 in the first scanning direction and the second scanning direction starting from the local alignment initiation point 212. For purposes of illustration, the maximum number of intermediate steps in the series of local alignment scans 260 is six while the number of steps N1 in the first scanning direction and the number of steps N2 in the second scanning direction is twelve for each direction. Due to the position of the beam spot 117 at startup (i.e., before the beam spot is positioned at the local alignment initiation point 212), the series of local alignment scans 260 reaches the maximum number of intermediate steps (three in this example) without the peak optical power of the wavelength conversion device exceeding the threshold optical power.

Under this scenario, once the series of local alignment scans 260 has been terminated without the beam spot 117 being aligned with the waveguide portion 124, the package controller may reposition the beam spot 117 to a global alignment initiation point 317 from which the beam spot 117 can be scanned over a larger percentage of the input facet 132 than was scanned with the series of local alignment scans 260. After the beam spot 117 is located at the global alignment initiation point 317, the beam spot 117 may be stepped in the intermediate scanning direction by a plurality of intermediate steps 320. Thereafter, a series of global alignment scans may be performed in the first scanning direction (i.e., in the positive y-direction) and the second scanning direction (i.e., the negative y-direction) with at least one intermediate step in the intermediate scanning direction between each global alignment scan. For example, a first global alignment scan may be performed in the first scanning direction by stepping the beam spot 117 in the first scanning direction by a first succession of steps 330. As described above, the peak output power for each step is determined at the end of each step in the alignment scan to determine if the beam spot 117 is aligned with the waveguide portion 124 of the wavelength conversion device. In the embodiment shown in FIG. 5A, the first alignment scan is completed without the beam spot 117 being aligned with the waveguide portion 124. Accordingly, a second global alignment scan may be performed in the second scanning direction by stepping the beam spot in the intermediate scanning direction by at least one intermediate step 236 and stepping the beam spot 117 in the second scanning direction by a second succession of steps 340. In the embodiment shown in FIG. 5A, the beam spot 117 is aligned with the waveguide portion 124 during the second succession of steps 340.

As described herein, the adaptive optics 130 of the wavelength converted light source 100 may utilize SIDM actuators. It has been determined that the amount of mechanical motion of the SIDM actuators per input pulse may vary by as much as 50% over the life of the actuator which, in turn, alters the size of the steps and the number of steps utilized to obtain alignment in a particularly scanning direction. Accordingly, in one embodiment, the package controller may track the number of steps needed to align the beam spot with the waveguide portion of the wavelength conversion device in a scanning direction and determines an average number of steps in the scanning direction needed to align the beams spot with the waveguide portion. If the package controller determines that the average number of steps needed to obtain alignment has increased, the controller may increase the number of pulses per step. Similarly, if the package controller determines that the average number of steps needed to obtain alignment has decreased, the controller may decrease the number of pulses per step. In this manner the physical size of the steps may be kept approximately the same over the life of the actuator. Similarly, the time taken to achieve alignment may also be kept constant over the life of the actuator.

It should now be understood that the methods described herein may be used to align wavelength converted light sources comprising a semiconductor laser optically coupled to a wavelength conversion device. The methods described herein are particularly applicable for use with wavelength converted light sources which utilize actuators with low positioning repeatability and/or high positioning variability between devices. Such actuators include SIDM actuators. For example, it has been determined the amount of displacement resulting from a constant position control signal comprising a single pulse or a plurality of pulses applied to an SIDM device may vary from device to device by a factor of up to about three. It has also been determined that the amount of displacement resulting from a constant position control signal comprising a single pulse or a plurality of pulses applied to an SIDM device may vary by as much as 50% over the life of the device. Each of these variations ultimately impacts the ability to effectively and repeatably align a wavelength converted light source which employs SIDM actuators and/or actuators with similar shortfalls. However, the alignment methods described herein may be used to overcome these shortfalls and improve repeatability in the alignment in addition to increasing the speed of alignment, particularly at the start-up of the device.

It will be apparent to those skilled in the art that various modifications and variations can be made to the embodiments described herein without departing from the spirit and scope of the claimed subject matter. Thus it is intended that the specification cover the modifications and variations of the various embodiments described herein provided such modification and variations come within the scope of the appended claims and their equivalents.

What is claimed is:

1. A method for aligning a semiconductor laser to a wavelength conversion device in a wavelength converted light source, the method comprising:
positioning a beam spot of the semiconductor laser on an input facet of the wavelength conversion device;
performing an alignment scan of the beam spot on the input facet by:
stepping the beam spot in a scanning direction by a succession of steps, wherein individual steps of the succession of steps comprise a start point and an end point;
initiating and terminating a sweep of a wavelength control signal of the semiconductor laser over an alignment signal range at the end point of individual steps of the succession of steps;
determining a peak output power of a wavelength converted output beam emitted from the wavelength conversion device during the sweep of the wavelength control signal of the semiconductor laser at the end point of individual steps of the succession of steps; and
comparing the peak output power of the wavelength converted output beam to a threshold output power, wherein the beam spot is aligned with a waveguide portion of the wavelength conversion device when the peak output power is greater than the threshold output power.

2. The method of claim 1 further comprising positioning the beam spot on an alignment initiation point prior to performing the alignment scan.

3. The method of claim 2 further comprising:
initiating and terminating an initial sweep of the wavelength control signal of the semiconductor laser over the alignment signal range prior to positioning the beam spot of the semiconductor laser on the alignment initiation point;
determining the peak output power of the wavelength converted output beam emitted from the wavelength conversion device during the initial sweep of the wavelength control signal of the semiconductor laser; and
comparing the peak output power of the wavelength converted output beam emitted from the wavelength conversion device during the initial sweep of the wavelength control signal to the threshold output power, wherein the beam spot of the semiconductor laser is aligned with the waveguide portion of the wavelength conversion device when the peak output power of the wavelength converted output beam is greater than the threshold output power.

4. The method of claim 2 further comprising advancing the beam spot away from the alignment initiation point by a plurality of intermediate steps in an intermediate scanning direction after positioning the beam spot of the semiconductor laser at the alignment initiation point on the input facet of the wavelength conversion device and before performing the alignment scan.

5. The method of claim 1 wherein a length of individual steps of the succession of steps is less than a length of an intermediate step.

6. A method for aligning a semiconductor laser to a wavelength conversion device in a wavelength converted light source, the method comprising:
positioning a beam spot of the semiconductor laser on an alignment initiation point on an input facet of the wavelength conversion device;
performing a first alignment scan of the beam spot on the input facet by:
stepping the beam spot in a first scanning direction by a first succession of steps;
sweeping a wavelength control signal of the semiconductor laser over an alignment signal range between individual steps of the first succession of steps;
determining a peak output power of a wavelength converted output beam emitted from the wavelength conversion device while the wavelength control signal of the semiconductor laser is swept between individual steps of the first succession of steps;
comparing the peak output power of the wavelength converted output beam to a threshold output power, wherein the beam spot is aligned with a waveguide portion of the wavelength conversion device when the peak output power is greater than the threshold output power;
performing a second alignment scan of the beam spot on the input facet when the peak output power does not exceed the threshold output power during the first alignment scan by:
stepping the beam spot away from an end point of the first alignment scan in an intermediate direction by at least one intermediate step;
stepping the beam spot in a second scanning direction opposite the first scanning direction by a second succession of steps;
sweeping the wavelength control signal of the semiconductor laser over the alignment signal range between individual steps of the second succession of steps;
determining the peak output power of the wavelength converted output beam emitted from the wavelength conversion device while the wavelength control signal of the semiconductor laser is swept between individual steps of the second succession of steps; and
comparing the peak output power of the wavelength converted output beam to the threshold output power, wherein the beam spot is aligned with the waveguide portion of the wavelength conversion device when the peak output power is greater than the threshold output power.

7. The method of claim 6 further comprising:
performing an initial sweep of the wavelength control signal of the semiconductor laser over the alignment signal range prior to positioning the beam spot on the alignment initiation point;
measuring an output power of the wavelength converted output beam emitted from the wavelength conversion device during the initial sweep of the wavelength control signal; and
comparing the output power of the wavelength converted output beam emitted from the wavelength conversion device during the initial sweep of the wavelength control signal to the threshold output power, wherein the beam spot of the semiconductor laser is aligned with the waveguide portion of the wavelength conversion device when the peak output power of the wavelength converted output beam is greater than the threshold output power.

8. The method of claim 6 further comprising advancing the beam spot away from the alignment initiation point by a plurality of intermediate steps in the intermediate direction before performing the first alignment scan.

9. The method of claim 6 wherein, when the peak output power exceeds the threshold output power, the method further comprises:
scanning the beam spot over the input facet on a first fine scanning axis;
measuring an output power of the wavelength converted output beam emitted from the wavelength conversion device while the beam spot is scanned on the first fine scanning axis;
identifying a first alignment set point of the beam spot on the first fine scanning axis such that the output power of the wavelength converted output beam is maximized;
scanning the beam spot over the input facet on a second fine scanning axis;
measuring the output power of the wavelength converted output beam emitted from the wavelength conversion device while the beam spot is scanned on the second fine scanning axis;
identifying a second alignment set point of the beam spot on the second fine scanning axis such that the output power of the wavelength converted output beam is maximized; and
positioning the beam spot on the input facet of the wavelength conversion device with the first alignment set point and the second alignment set point.

10. The method of claim 9 further comprising initiating closed-loop feedback control of the wavelength converted light source after the beam spot is positioned on the input facet of the wavelength conversion device with the first alignment set point and the second alignment set point.

11. The method of claim 9 further comprising determining the wavelength control signal such that the output power of the wavelength conversion device is maximized after the beam spot is positioned on the input facet of the wavelength conversion device with the first alignment set point and the second alignment set point.

12. The method of claim 6, wherein:
the alignment initiation point is a local alignment initiation point;
the first alignment scan is a first local alignment scan; and
the second alignment scan is a second local alignment scan.

13. The method of claim 6, wherein:
the alignment initiation point is a global alignment initiation point;
the first alignment scan is a first global alignment scan; and
the second alignment scan is a second global alignment scan.

14. The method of claim 6 wherein a number of steps N1 in the first succession of steps is less than a number of steps N2 in the second succession of steps.

15. The method of claim 14 wherein N2=1.3*N1.

16. The method of claim 6 further comprising:
determining an average number of steps utilized to align the beam spot with the waveguide portion of the wavelength conversion device in a scanning direction; and
adjusting a number of pulses in a position control signal corresponding to each step in the scanning direction when the average number of steps utilized to align the beam spot with the waveguide portion of the wavelength conversion device changes.

17. The method of claim 6 wherein a length of individual steps of the first succession of steps and a length of individual steps of the second succession of steps are less than a length of an intermediate step.

18. The method of claim 6, wherein:
a fundamental beam of the semiconductor laser is optically coupled to the wavelength conversion device with a collimating lens and a focusing lens;
the beam spot of the semiconductor laser is stepped in the first scanning direction by adjusting a position of the collimating lens with an actuator coupled to the collimating lens; and
the beam spot of the semiconductor laser is stepped in the intermediate direction by adjusting a position of the focusing lens with an actuator coupled to the focusing lens.

19. The method of claim 18 wherein:
a number of steps N1 in the first succession of steps corresponds to a range of travel of the actuator coupled to the collimating lens which is less than a maximum range of travel of the actuator coupled to the collimating lens; and
a number of steps N2 in the second succession of steps corresponds to a range of travel of the actuator which is less than the maximum range of travel of the actuator coupled to the collimating lens.

20. The method of claim 18, wherein the actuator coupled to the focusing lens and the actuator coupled to the collimating lens are smooth impact drive mechanisms.
